(19) United States
(12) Patent Application Publication
(10) Pub. No.: US 2020/0025573 A1
(43) Pub. Date: Jan. 23, 2020

(54) POSITIONING SYSTEM AND METHOD USING LAMP FIXTURE INDICATOR

(71) Applicant: General Electric Company, Schenectady, NY (US)

(72) Inventors: Nina Rose SCHEIDEGGER, Cleveland, OH (US); Phillip James ELLIS, Willoughby, OH (US); Himamshu Viswat Prasad, Cleveland, OH (US); David Joseph Kachmarik, Strongsville, OH (US); Colin Drew McKibben, Cleveland, OH (US); Jeffrey Marc NALL, Brecksville, OH (US)

(21) Appl. No.: 16/040,099

(22) Filed: Jul. 19, 2018

(51) Int. Cl. G01C 21/20; G01C 21/00; G06K 9/00; G06K 9/46; F21V 3/04

(52) U.S. Cl. CPC G01C 21/206; G01C 21/005; F21V 3/049; G06K 9/4661; G06K 9/00664

(57) ABSTRACT

A system and method obtaining image data of a light fixture having an indicator associated with the light fixture. The indicator at least partially attenuates light generated by one or more light generating devices disposed within the light fixture. The method also includes determining one or more characteristics of the indicator based on the image data that is obtained, and one or more of determining a unique identity of the light fixture based on the one or more characteristics of the indicator that are determined or determining a location of the light fixture within a structure based on the one or more characteristics of the indicator that are determined.

### BACKGROUND

A variety of positioning systems operate to help find locations of persons and objects. For example, global positioning system receivers can receive satellite signals to determine the geographic locations of the receivers. But, these receivers may not work indoors or in areas where the satellite signals are not received or are significantly weakened. Wireless triangulation systems can be used, but these systems may lack the precision desired in determining locations inside structures. Other wireless positioning systems and techniques, such as BLUETOOTH low energy (or BLE), have shown to be less accurate in determining locations than other systems or techniques.

Other positioning systems can use modulated light that is generated by indoor lamp fixtures. Drivers of light emitting diodes in the lamp fixtures can modulate the light generated by different lamp fixtures in different ways. Cameras capture information about the modulated light from at least two different lamp fixtures. For example, a camera can obtain image data of at least two lamp fixtures that are concurrently generating light that is modulated in different ways, such as by changing the amplitude, phase, and/or polarization of the light in different ways. A device can examine this image data and determine which lamp fixtures are creating the differently modulated light. Based on the identification of the two or more lamp fixtures, the device can determine where the camera is located.

These light modulation positioning systems are not without shortcomings. For example, the camera may be required to obtain modulated light created by two or more different lamp fixtures at the same time for the device to be able to determine the location of the camera. Additionally, the camera may need to be held in a designated orientation relative to the lamp fixtures and/or may need to be held at a designated distance from the lamp fixtures for the device to be able to detect or identify the light modulation. Otherwise, the camera and device may not be able to detect or identify the light modulation, and therefore may not be able to identify the location of the camera. The modulation of light can require expensive drivers and software solutions for the lamp fixtures, which can significantly add to the installation and maintenance costs of a lighting system.

### BRIEF DESCRIPTION

In one embodiment, a method includes obtaining image data of a light fixture having an indicator associated with the light fixture (using an optical sensor). The indicator at least partially attenuates light generated by one or more light generating devices of the light fixture prior to the light falling on (e.g., being detected by) the optical sensor. The method also includes determining one or more characteristics of the indicator based on the image data that is obtained, and one or more of determining a unique identity of the light fixture based on the one or more characteristics of the indicator that are determined or determining a location of the light fixture within a structure based on the one or more characteristics of the indicator that are determined.

In one embodiment, an electronic mobile device includes an optical sensor configured to obtain image data of a light fixture having an indicator associated with the light fixture. The indicator at least partially attenuates light generated by one or more light generating devices of the light fixture prior to the light falling on the light sensor. The device also includes one or more processors configured to determine one or more characteristics of the indicator based on the image data that is obtained. The one or more processors also are configured to one or more of determine a unique identity of the light fixture based on the one or more characteristics of the indicator that are determined or determine a location of the light fixture within a structure based on the one or more characteristics of the indicator that are determined.

In one embodiment, a method includes obtaining image data of a light fixture having an indicator using an optical sensor. The indicator includes one or more of a missing light-generating device in a repeating pattern of light-generating devices in the light fixture or a body affixed to the light fixture and that at least partially attenuates light generated by one or more light generating devices of the light fixture. The method also includes determining one or more characteristics of the indicator based on the image data that is obtained, and one or more of determining a unique identity of the light fixture based on the one or more characteristics of the indicator that are determined and/or determining a location of the light fixture within a structure based on the one or more characteristics of the indicator that are determined.

### BRIEF DESCRIPTION OF THE DRAWINGS

The present inventive subject matter will be better understood from reading the following description of non-limiting embodiments, with reference to the attached drawings, wherein below:

FIG. 1 illustrates one embodiment of a positioning system;

FIG. 2 illustrates one example of a lamp fixture shown in FIG. 1;

FIG. 3 illustrates one example of a mobile electronic device shown in FIG. 1;

FIG. 4 illustrates another example of an identifying indicator on a lamp fixture shown in FIG. 1;

FIG. 5 illustrates one example of an identifying indicator and a reference indicator on a lamp fixture shown in FIG. 1;

FIG. 6 illustrates another example of an identifying indicator on a lamp fixture shown in FIG. 1; and

FIG. 7 illustrates a flowchart of one embodiment of a method for uniquely identifying a lamp fixture.

The components shown in the drawings may not be drawn to scale.

### DETAILED DESCRIPTION

The inventive subject matter described herein relates to positioning systems and methods that identify locations and/or unique identities of lamp fixtures using lamp identifying indicators. The systems and methods can be used to accurately and precisely determine indoor locations within a structure, such as a building. In one embodiment, the identifying indicator is a body that is placed onto a specified location on the lamp fixture to indicate a unique identity of the fixture. There are multiple ways and materials that can be utilized to implement this functionality. One example involves placing a visible identifying indicator on the fixture that covers a portion of the fixture. The indicator is uniquely associated with the fixture in that the indicator is located inside the fixture (in a visible location), outside of the fixture, adjacent to the fixture, or integral to the fixture. The indicator changes the appearance of light generated by the fixture in such a way that the indicator can be used to uniquely identify the fixture.

This identifying indicator can be translucent or opaque. The identifying indicator can be different sizes and/or shapes to allow for a wide variety of combinations of identifying indicators to be used to uniquely identify many different lamp fixtures. Additionally, the identifying indicator can be formed from a single body, or from multiple separate bodies to allow for many more unique identities to be created. Additionally or alternatively, the identifying indicator can also be created by removing one or more light generating devices (e.g., light-emitting diodes) from the fixture to create the unique identity.

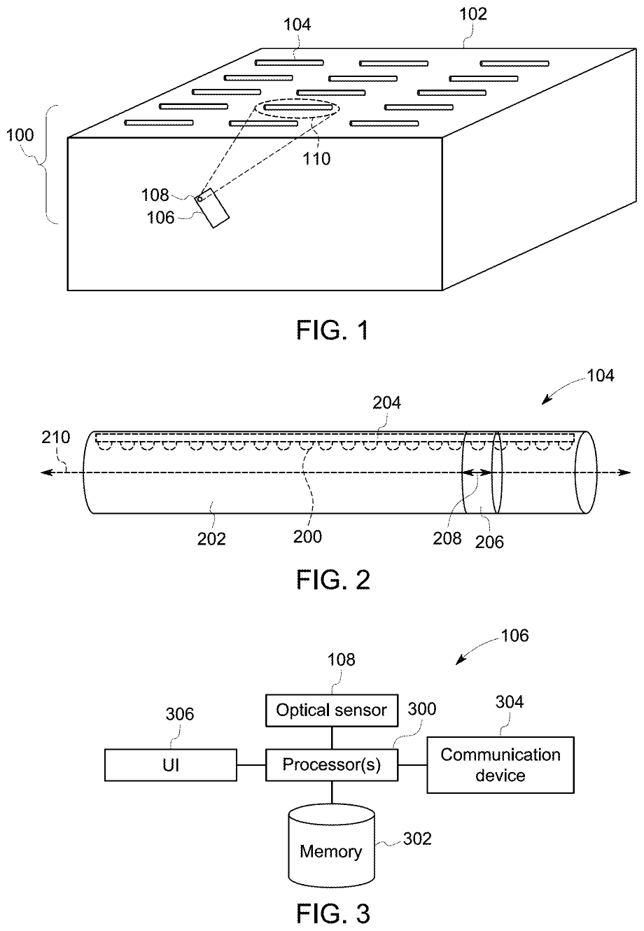

FIG. 1 illustrates one embodiment of a positioning system 100. The positioning system 100 can be used to determine indoor locations within a structure 102 having one or more lamp fixtures 104, such as a building. The positioning system 100 can be useful in outdoor locations or other locations where global positioning system receivers, BLUETOOTH low energy systems, or light modulation systems are less accurate or useful to determine locations in the structure 102 and/or to uniquely identify lamp fixtures 104. The positioning system 100 includes one or more identifying indicators (not visible in FIG. 1) and an electronic device 106. The identifying indicators are positioned outside of light-generating devices (not visible in FIG. 1) in the lamp fixtures 104.

The electronic device 106 can be a mobile electronic device that includes an optical sensor 108 and hardware circuitry that includes and/or is coupled with one or more processors (e.g., one or more microprocessors, one or more field programmable gate arrays, one or more integrated circuits, or the like) that perform the functions described herein in connection with the electronic device 106. The optical sensor 108 can be a camera or other sensor that detects light emitted from or generated by the lamp fixtures 104. In one embodiment, the electronic device 106 is a hand-held, mobile device, such as a mobile phone, tablet computer, or the like.

FIG. 2 illustrates one example of a lamp fixture 104 shown in FIG. 1. The lamp fixture 104 includes several light-generating devices 200, such as light-emitting diodes (LEDs). Alternatively, the lamp fixture 104 may include a single light-generating device 200 or one or more light-generating devices 200 other than LEDs (e.g., incandescent bulbs, fluorescent bulbs, halogen bulbs, metal halide lamps, sodium lamps, etc.). The lamp fixture 104 is shown as an elongated fixture, but alternatively may have another shape. The devices 200 can be conductively coupled with circuitry 204, such as a circuit board, that controls conduction of current to power the devices 200 and that can include or be connected with hardware circuitry for controlling the devices 200, such as drivers. Although not shown in FIG. 2, the devices 200 and circuitry 204 can be conductively coupled with one or more power sources, such as a utility power grid, a solar panel, batteries, or the like.

The lamp fixture 104 optionally includes an outer lens 202 that defines an outer surface of the lamp fixture 104 through which light generated by the light-generating devices 200 leaves the lamp fixture 104 (e.g., to illuminate an area of the structure 102 shown in FIG. 1). The devices 200 are disposed within the lens 202, as shown in FIG. 2. The outer surface of the lens 202 can be the last surface that the light created by the devices 200 passes through before illuminating areas of the structure 102, such as the floor or walls of the structure 102.

In the illustrated embodiment, an identifying indicator 206 is associated with the fixture 104. For example, the indicator 206 can be attached to the outer surface of the lens 202 of the lamp fixture 104, can be attached to an inner surface of the lens 202, can be coupled with the fixture 104 but not the lens 202, can be integrally formed in the body of the fixture 104, or the like. The indicator 206 can be markings or stripes on a non-light-emitting white reflector of the fixture 104, thereby creating an altered image for the appearance of the light fixture 104 in the optical sensor.

The identifying indicator 206 shown in FIG. 2 is a single body indicator. The identifying indicator 206 can be adhered to the lens 202, such as an elongated section of a material, such as tape. Alternatively, the identifying indicator 206 may not be adhered to the lens 202, such as an elongated elastic band that wraps around the lens 202 or around the devices 200 on the inner surface of the lens 202. The identifying indicator 206 need not wrap entirely around the outer circumference or surface of the lens 202. For example, the identifying indicator 206 may be a shorter or smaller segment of a body that is coupled with the lens 202. In another embodiment, the identifying indicator 206 can be coupled to an inner surface of the lens 202.

The identifying indicator 206 can be opaque such that light does not pass through the identifying indicator 206 (e.g., the body of the indicator 206 completely attenuates the light directed onto one side of the indicator 206). Alternatively, the identifying indicator 206 can be partially opaque to the light, such that at least part of the light passes through the identifying indicator 206 while another part of the light is attenuated and diffused by the identifying indicator 206. For example, the identifying indicator 206 can be translucent. The identifying indicator 206 can have one or more different colors (either opaque or tinted with color).

In operation (and as shown in FIG. 1), the mobile electronic device 106 is positioned so that at least a single lamp fixture 104 is within a field of view 110 of the optical sensor 108. The field of view 110 of the optical sensor 108 represents the observable area or volume that a person can view based on the image data generated by the optical sensor 108. In one embodiment, the field of view 110 of the optical sensor 108 can include only a single lamp fixture 104, with no other lamp fixture 104 or portion of another lamp fixture 104 being visible. Alternatively, the field of view 110 can include two or more of the lamp fixtures 104. The mobile electronic device 106 can be positioned in any of a variety of orientations relative to the lamp fixture 104 so long as the identifying indicator 206 (and, optionally, another reference indicator, as described below) are within the field of view 110 of the optical sensor 108. For example, from a position to be determined, the mobile electronic device 106 and optical sensor 108 can be rotated or angled relative to the lamp fixture 104 to any orientation relative to the lamp fixture 104 and the identifying indicator 206 (and/or reference indicator), so long as the identifying indicator 206 (and, optionally, the reference indicator) are viewable within the field of view 110 of the optical sensor 108. The same location of the optical sensor 108 and/or mobile electronic device 106 can be determined (as described herein) regardless of where the indicator(s) appear in the field of view 110 in one embodiment.

The identifying indicator 206 can at least partially attenuate the light generated by the light-generating devices 200 as the light passes through the lens 202 and/or around the indicator 206. The mobile electronic device 106 examines the image data that captures the identifying indicator 206, the attenuated light, and/or the reference indicator (described below), and determines one or more characteristics of the identifying indicator 206 from the image data.

The mobile electronic device 106 then determines a unique identity of the lamp fixture 104 based on the characteristic(s) of the identifying indicator 206 that is or are determined. This identity may be unique to the lamp fixture 104 in that no other lamp fixture 104 in the same structure 102 has the same identity. Alternatively, different lamp fixtures 104 in different portions of the structure 102 (e.g., different rooms or different floors) may have the same identity. Alternatively, different lamp fixtures 104 in different structures 102 may have the same identity.

Using this unique identity, the mobile electronic device 106 can determine where the mobile electronic device 106 and/or optical sensor 108 are located within the structure 102. For example, the mobile electronic device 106 can refer to a list, table, map, or other memory structure stored in a memory of or associated with the mobile electronic device 106 that associates different unique identities of the lamp fixtures 104 with different locations. The mobile electronic device 106 can determine that the location of the mobile electronic device 106 and/or optical sensor 108 is the same as the location associated with the lamp fixture 104 that is identified.

FIG. 3 illustrates one example of the mobile electronic device 106 shown in FIG. 1. All or some of the components of the mobile electronic device 106 can be disposed within a single housing. For example, the components shown in FIG. 3 may be disposed in a single outer housing such that the device 106 is a single mobile unit. Alternatively, one or more of the components of the mobile electronic device 106 can be disposed in different housings and/or in different locations, such that the mobile electronic device 106 is an assembly having disparate components in disparate locations. The connections between the components of the mobile electronic device 106 can represent wired and/or wireless connections. Components that are not directly coupled with each other in FIG. 3 optionally may be directly coupled with each other.

The mobile electronic device 106 includes one or more processors 300 that perform the operations described herein in connection with the mobile electronic device 106. For example, the processors 300 can examine image data from the optical sensor 108 to determine characteristics of indicators, identify the indicators from the characteristics, and determine locations of the mobile electronic device 106 and/or optical sensor 108 from the characteristics. The processors 300 represent one or more microprocessors, one or more field programmable gate arrays, one or more integrated circuits, and/or associated hardware circuitry.

The mobile electronic device 106 also includes or has access to a memory 302, which represents one or more tangible and non-transitory computer readable storage media. Examples of the memory 302 include computer hard drives, optical discs, removable drives, servers, and the like. The memory 302 may be internal to the mobile electronic device 106, or may at least partially be external to the device 106. The processors 300 can read data from and optionally write data to the memory 302 directly or via one or more communication devices 304. The communication device 304 represents hardware circuitry (the same or different from the circuitry of the processors 300) that includes and/or is connected with one or more transceivers, antennas, receivers, transmitters, or the like, to allow for the mobile electronic device 106 to communicate with other devices.

The mobile electronic device 106 can include a user interface 306 that communicates information to and/or receives input from an operator of the mobile electronic device 106. The user interface 306 can represent a display device, a touchscreen, a keyboard, a stylus, an electronic mouse, a speaker, a microphone, or the like. The user interface 306 can inform the operator of the identity of the lamp fixture 104 and/or location of the mobile electronic device 106, as determined by the processors 300.

Returning to the description of the example identifying indicator 206 shown in FIG. 1, the processors 300 can determine a size of the indicator 206 as a characteristic of the indicator 206. In one example, the size of the indicator 206 can be a width 208 of the indicator 206. The width 208 can be a measurement of the widest portion of the indicator 206 along or parallel to a designated direction, such as a direction that extends along a center axis 210 of the lens 202 or lamp fixture 104. Different widths 208 of the indicator 206 can be associated with different lamp fixtures 104 in the memory 302 such that the processors 300 can determine the unique identity of the lamp fixture 104 based on the width 208 of the indicator 206.

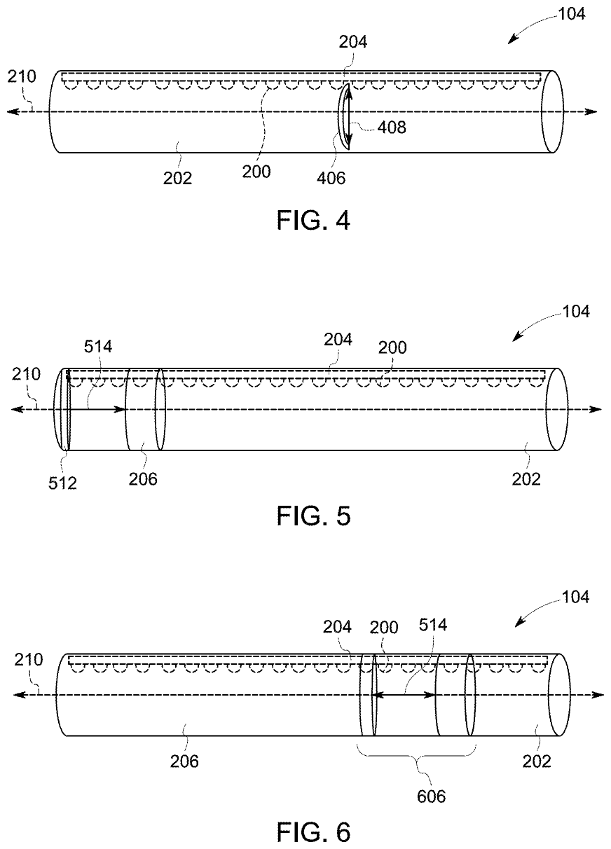

FIG. 4 illustrates another example of an identifying indicator 406 on the lamp fixture 104. The identifying indicator 406 differs from the identifying indicator 206 shown in FIG. 2 in that the identifying indicator 406 does not extend around or encircle the lens 202 or center axis 210 of the lens 202. For example, the indicator 206 may be an elongated body that is shorter than an outer circumference or perimeter of the lens 202. The processors 300 of the mobile electronic device 106 can measure a length 408 of the indicator 406 as a characteristic of the indicator 406. Different lengths 408 of indicators 406 can be associated with different lamp fixtures 104 in the memory 302. The processors 300 can examine the image data to determine the length 408 of an indicator 406 to identify the lamp fixture 104 to which the indicator 406 is coupled.

As another example, the amount by which light is attenuated by the identifying indicator can be a characteristic of the indicator. The processors 300 can examine the image data to determine how much light is attenuated by the identifying indicator. For example, opaque identifying indicators can attenuate more light and appear darker in the image data when compared with translucent or less opaque identifying indicators. The processors 300 can examine the image data to determine how much light is attenuated by the identifying indicator. Different amounts of light attenuation can be associated with different lamp fixtures in the memory 302, and the processors 300 can identify the lamp fixture 104 to which the identifying indicator is attached to identify the lamp fixture 104 using the amount of light attenuation that is determined.

As another example, the color of the identifying indicator can be a characteristic of the indicator. The processors 300 can examine the image data to determine the color of the identifying indicator. Different colors can be associated with different lamp fixtures in the memory 302, and the processors 300 can identify the lamp fixture 104 to which the identifying indicator is attached to identify the lamp fixture 104 using the color that is identified.

As another example, a characteristic that is determined includes a location of the identifying indicator on the lamp fixture 104. Different locations on the lamp fixture 104 can be associated with different lamp fixtures 104, and the processors 300 can examine the image data to identify the lamp fixture 104 using the location where the identifying indicator is located.

FIG. 5 illustrates one example of the identifying indicator 206 and a reference indicator 512 on the lamp fixture 104. The reference indicator 512 can be a marking or body on or coupled with the lamp fixture 104. For example, the reference indicator 512 can be tape, paint, a sticker, or the like, that is adhered or coupled to the lamp fixture 104. Alternatively, the reference indicator 512 can be an object or mechanical feature of the lamp fixture 104, such as a wire connector, label, interface between the lens 202 and one part of the lamp fixture 104, or the like. In another example, the reference indicator 512 can be a light-generating device 200 that is deactivated, that is generating light of a different color than other devices 200 in the lamp fixture 104, that is generating light of a different brightness than other devices 200 in the lamp fixture 104, or the like.

The reference indicator 512 can provide a designated location on the lamp fixture 104 from which a characteristic of the identifying indicator is to be determined. For example, the processors 300 can examine the image data to identify where the reference indicator 512 is located, and can measure a separation distance 514 between the reference and identifying indicators. This separation distance 514 can represent how far the identifying indicator is from the reference indicator 512. This distance 514 can be measured along the center axis 210 of the lens 202 or lamp fixture 104, or along another direction. In one embodiment, the distance 514 is the shortest distance between the reference and identifying indicators.

Different separation distances 514 between reference indicators 512 and identifying indicators can be associated with different lamp fixtures 104. The processors 300 can examine the image data to determine the separation distance 514 associated with a lamp fixture 104 to identify the lamp fixture 104.

FIG. 6 illustrates another example of an identifying indicator 606 on the lamp fixture 104. The identifying indicator 606 is formed from two separate bodies 608, 610, in contrast to the embodiments described herein that use a single body identifying indicator. Each of the separate bodies 608, 610 can have a different size, such as a different width (as shown in FIG. 6) and/or a different length. Alternatively, the separate bodies 608, 610 of the identifying indicator 606 can be the same size. While the identifying indicator 606 is shown as being formed from two separate bodies 608, 610, alternatively, the identifying indicator 606 may be formed from three or more separate bodies and/or two or more of the bodies may be joined with each other (e.g., by a horizontal section or other section).

The characteristic of the multi-body identifying indicator 606 can be a difference between the bodies 608, 610. For example, the processors 300 can examine the image data to determine the separation distance 514 between the identifying indicator bodies 608, 610 as a difference in locations of the bodies 608, 610 as the characteristic. Optionally, the processors 300 can examine the image data to determine widths 208 of the bodies 608, 610 and a difference in the widths 208 of the bodies 608, 610 as the characteristic. As another example, the processors 300 can examine the image data to determine lengths 408 of the bodies 608, 610 and a difference in the lengths 408 of the bodies 608, 610 as the characteristic. As another example, the processors 300 can examine the image data to determine how much light is attenuated by the bodies 608, 610 and a difference in the amount of light attenuation between the bodies 608, 610 as the characteristic.

Different separation distances 514 between the bodies 608, 610, differences in widths 208 between the bodies 608, 610, differences in lengths 408 between the bodies 608, 610, attenuation differences between the bodies 608, 610, or other differences between the bodies 608, 610 can be associated in the memory 302 with different lamp fixtures 104. The processors 300 can examine the image data to determine the difference(s) between the identifying indicator bodies 608, 610 associated with a lamp fixture 104 to identify the lamp fixture 104.

In one embodiment, a combination of characteristics of indicator(s) on lamp fixture 104 can be determined by the processors 300 from the image data to uniquely identify the lamp fixture 104. For example, two or more of a width 208 of a body of an identifying indicator, a length 408 of the body of the same identifying indicator, a separation distance 514 of the body of the same identifying indicator from a reference indicator, an amount of light attenuation by the same identifying indicator, a color of the same identifying indicator, a separation distance 514 between two bodies of the same identifying indicator, multiple separation distances 514 between three or more bodies of the same identifying indicator, a width difference between two bodies of the same identifying indicator, multiple width differences between three or more bodies of the same identifying indicator, amounts of light attenuation by different bodies of the same identifying indicator, differences in amounts of light attenuation by different bodies of the same identifying indicator, and/or a combination of colors of different bodies of the same identifying indicator. The combination of characteristics can be determined by the processors 300 examining the image data. Different combinations of the characteristics can be associated with different lamp fixtures 104 in the memory 302, and the processors 300 can identify the lamp fixture 104 based on the combination of characteristics that is determined from the image data.

Different lamp fixtures 104 can be identified as described herein, and the identifications can be used in different ways. In one example, an identified lamp fixture 104 can be associated with a location within the structure 102 in the memory 302. The processors 300 can use the identified lamp fixture 104 to determine where the mobile electronic device 106 is located in the structure 102. As another example, the identified lamp fixture 104 can be associated with a maintenance schedule (e.g., that involves replacing a light-generating device 200 in the fixture 104 or other maintenance) in the memory 302, and identifying the lamp fixture 104 can help the processors 300 determine what maintenance is needed for the lamp fixture 104 and/or when the maintenance is needed.

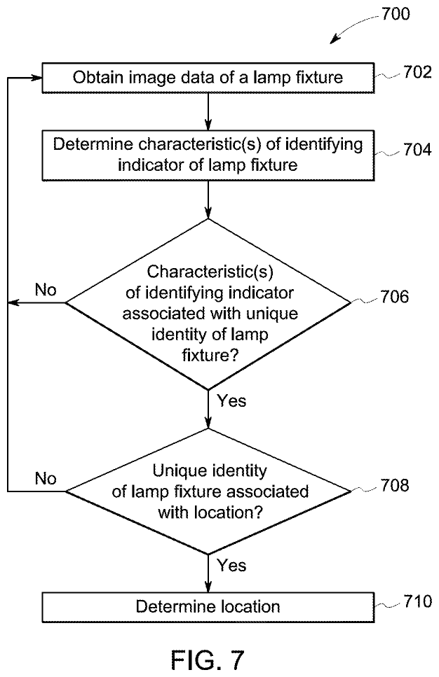

FIG. 7 illustrates a flowchart of one embodiment of a method 700 for uniquely identifying a lamp fixture. The method 700 can represent the operations performed by the mobile electronic device 106 pursuant to directions provided by the processors 300. At 702, image data of a lamp fixture is obtained. As described above, the optical sensor 108 of the mobile electronic device 106 can generate images and/or videos of a lamp fixture 104. In one embodiment, only a single lamp fixture 104 may appear in the image data. Alternatively, multiple lamp fixtures 104 may appear in the image data. The image data can be obtained from a variety of different orientations of the optical sensor 108 relative to the lamp fixture 104, and no single orientation is required in at least one embodiment.

At 704, one or more characteristics of an identifying indicator on the lamp fixture are determined from the image data. The processors 300 can determine locations, widths, lengths, amounts of light attenuation, colors, separation distances, or the like, of the identifying indicator(s) on the lamp fixture 104, as described above. This information can be determined by the processors 300 examining the image data.

At 706, a determination is made as to whether the characteristic(s) of the identifying indicator are associated with a unique identity of a lamp fixture. For example, different locations, widths, lengths, amounts of light attenuation, colors, separation distances, or the like, of the identifying indicator(s) on the lamp fixture 104, or different combinations of two or more of these characteristics, can be associated with different individual ones of the lamp fixtures 104. One lamp fixture 104 can be associated with a single-body, opaque identifying indicator that is two centimeters wide and five centimeters from a reference indicator, another lamp fixture 104 can be associated with a multi-body, opaque identifying indicator that is two centimeters wide and five centimeters from a reference indicator, another lamp fixture 104 can be associated with a single-body, translucent identifying indicator that is two centimeters wide and five centimeters from a reference indicator, another lamp fixture 104 can be associated with a multi-body, translucent identifying indicator that is two centimeters wide and five centimeters from a reference indicator, another lamp fixture 104 can be associated with a single body, opaque identifying indicator that is four centimeters wide and five centimeters from a reference indicator, another lamp fixture 104 can be associated with a single body, opaque identifying indicator that is four centimeters wide and ten centimeters from a reference indicator, and so on. The more characteristics that define or are associated with a unique identity of a lamp fixture 104, the more lamp fixtures 104 can be uniquely identified by the identifying indicators.

If the characteristic or combination of characteristics is associated with a unique identity of a lamp fixture, then flow of the method 700 can proceed toward 708. Otherwise, the method 700 can return toward 702 to obtain image data of another lamp fixture, or the method 700 can terminate.

At 708, a determination is made as to whether the unique identity of the lamp fixture is associated with a location. Different identities of different lamp fixtures can be associated with different locations in a structure. If the identity of the lamp fixture that was determine is associated with a location in the structure, then flow of the method 700 can proceed toward 710. Otherwise, the method 700 can return toward 702 to obtain image data of another lamp fixture, or the method 700 can terminate.

At 710, a location is determined. This location can be the location of the mobile electronic device or other electronic device that obtained the image data of the lamp fixture. This location can be used to determine where equipment or machinery (e.g., forklifts, carts, etc.) is located in large structures, without having to rely on light modulation, global positioning system receivers, BLUETOOTH low energy systems, wireless triangulation systems, or the like, which may not work, may not be accurate, or may have less precision than one or more embodiments of the inventive subject matter described herein.

In one embodiment, a method includes obtaining image data of a light fixture having an indicator disposed outside of a lens of the light fixture (using an optical sensor). The indicator at least partially attenuates light generated by one or more light generating devices disposed within the lens of the light fixture. The method also includes determining one or more characteristics of the indicator based on the image data that is obtained, and one or more of determining a unique identity of the light fixture based on the one or more characteristics of the indicator that are determined or determining a location of the light fixture within a structure based on the one or more characteristics of the indicator that are determined.

Optionally, the optical sensor is a camera of a mobile electronic device.

Optionally, the indicator is an elongated section of a light-attenuating material adhered to the lens of the light fixture.

Optionally, the indicator is opaque to the light generated by the one or more light generating devices.

Optionally, the indicator is partially opaque to the light generated by the one or more light generating devices.

Optionally, the one or more characteristics of the indicator include a location of the indicator on the light fixture.

Optionally, the one or more characteristics of the indicator include a distance of the indicator from a designated location on the light fixture.

Optionally, the one or more characteristics of the indicator include a size of the indicator.

Optionally, the one or more characteristics of the indicator include a width of the indicator.

Optionally, the one or more characteristics of the indicator include a length of the indicator.

Optionally, the one or more characteristics of the indicator include an amount of attenuation of the light that is caused by the indicator.

Optionally, the indicator is formed from two or more separate bodies, and the one or more characteristics of the indicator include a difference between the two or more separate bodies.

Optionally, the difference between the two or more separate bodies includes one or more of a distance between the separate bodies, a width difference between the separate bodies, or an attenuation difference between the separate bodies.

In one embodiment, an electronic mobile device includes an optical sensor configured to obtain image data of a light fixture having an indicator disposed outside of a lens of the light fixture. The indicator at least partially attenuates light generated by one or more light generating devices disposed within the lens of the light fixture. The device also includes one or more processors configured to determine one or more characteristics of the indicator based on the image data that is obtained. The one or more processors also are configured to one or more of determine a unique identity of the light fixture based on the one or more characteristics of the indicator that are determined or determine a location of the light fixture within a structure based on the one or more characteristics of the indicator that are determined.

Optionally, the optical sensor is a camera. The indicator can be an elongated section of a light-attenuating material adhered to the lens of the light fixture. The indicator can be opaque to the light generated by the one or more light generating devices. Optionally, the indicator can be partially opaque to the light generated by the one or more light generating devices. The one or more characteristics of the indicator can include a location of the indicator on the light fixture.

In one embodiment, a method includes obtaining image data of a light fixture having an indicator using an optical sensor. The indicator includes one or more of a missing light-generating device in a repeating pattern of light-generating devices in the light fixture or a body affixed to the light fixture in a location that is outside of a lens of the light fixture and that at least partially attenuates light generated by one or more light generating devices disposed within the lens of the light fixture. The method also includes determining one or more characteristics of the indicator based on the image data that is obtained, and one or more of determining a unique identity of the light fixture based on the one or more characteristics of the indicator that are determined and/or determining a location of the light fixture within a structure based on the one or more characteristics of the indicator that are determined.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
using an optical sensor, obtaining image data of a light fixture having an indicator associated with the light fixture, the indicator at least partially attenuating light generated by one or more light generating devices disposed within the light fixture prior to the light falling on the optical sensor;
determining one or more characteristics of the indicator based on the image data that is obtained; and
one or more of determining a unique identity of the light fixture based on the one or more characteristics of the indicator that are determined or determining a location of the light fixture within a structure based on the one or more characteristics of the indicator that are determined.

2. The method of claim 1, wherein the optical sensor is a camera of a mobile electronic device.

3. The method of claim 1, wherein the indicator is an elongated section of a light-attenuating material adhered to the light fixture.

4. The method of claim 1, wherein the indicator is opaque to the light generated by the one or more light generating devices.

5. The method of claim 1, wherein the indicator is partially opaque to the light generated by the one or more light generating devices.

6. The method of claim 1, wherein the one or more characteristics of the indicator include a location of the indicator on the light fixture.

7. The method of claim 1, wherein the one or more characteristics of the indicator include a distance of the indicator from a designated location on the light fixture.

8. The method of claim 1, wherein the one or more characteristics of the indicator include a size of the indicator.

9. The method of claim 1, wherein the one or more characteristics of the indicator include a width of the indicator.

10. The method of claim 1, wherein the one or more characteristics of the indicator include a length of the indicator.

11. The method of claim 1, wherein the one or more characteristics of the indicator include an amount of attenuation of the light that is caused by the indicator.

12. The method of claim 1, wherein the indicator is formed from two or more separate bodies, and wherein the one or more characteristics of the indicator include a difference between the two or more separate bodies.

13. The method of claim 12, wherein the difference between the two or more separate bodies includes one or more of a distance between the separate bodies, a width difference between the separate bodies, or an attenuation difference between the separate bodies.

14. An electronic mobile device comprising:
an optical sensor configured to obtain image data of a light fixture having an indicator associated with the light fixture, the indicator at least partially attenuating light generated by one or more light generating devices disposed the light fixture prior to the light falling on the optical sensor; and
one or more processors configured to determine one or more characteristics of the indicator based on the image data that is obtained, the one or more processors also configured to one or more of determine a unique identity of the light fixture based on the one or more characteristics of the indicator that are determined or determine a location of the light fixture within a structure based on the one or more characteristics of the indicator that are determined.

15. The mobile electronic device of claim 14, wherein the optical sensor is a camera.

16. The mobile electronic device of claim 14, wherein the indicator is an elongated section of a light-attenuating material adhered to the light fixture.

17. The mobile electronic device of claim 14, wherein the indicator is opaque to the light generated by the one or more light generating devices.

18. The mobile electronic device of claim 14, wherein the indicator is partially opaque to the light generated by the one or more light generating devices.

19. The mobile electronic device of claim 14, wherein the one or more characteristics of the indicator include a location of the indicator on the light fixture.

20. A method comprising:
using an optical sensor, obtaining image data of a light fixture having an indicator, the indicator including one or more of a missing light-generating device in a repeating pattern of light-generating devices in the light fixture or a body affixed to the light fixture and that at least partially attenuates light generated by one or more light generating devices of the light fixture prior to the light being detected by the optical sensor;
determining one or more characteristics of the indicator based on the image data that is obtained; and
one or more of determining a unique identity of the light fixture based on the one or more characteristics of the indicator that are determined or determining a location of the light fixture within a structure based on the one or more characteristics of the indicator that are determined.
